(19) United States
(12) Patent Application Publication
(10) Pub. No.: US 2025/0373738 A1
(43) Pub. Date: Dec. 4, 2025

(54) DISPLAY CONTROL APPARATUS, CONTROL METHOD, AND STORAGE MEDIUM

(71) Applicant: CANON KABUSHIKI KAISHA, Tokyo (JP)

(72) Inventor: HAYATO SHIRAI, Kanagawa (JP)

(21) Appl. No.: 19/196,570

(22) Filed: May 1, 2025

(30) Foreign Application Priority Data
May 30, 2024 (JP) 2024-087665

(51) Int. Cl. H04N 1/00; H04N 1/32

(52) U.S. Cl. CPC H04N 1/00408; H04N 1/00387; H04N 1/00488; H04N 1/32101; H04N 2201/3269

(57) ABSTRACT

A display control apparatus including an operation unit for receiving operation from a user, and a display unit, the display control apparatus includes a display control unit configured to display a predetermined code on the display unit, wherein, in a case where the predetermined code is displayed on the display unit, and the key with the first attribute is operated, a control unit performs the first processing, and in a case where the predetermined code is displayed on the display unit, and the key with the second attribute is operated, the control unit performs processing for hiding the predetermined code without performing the second processing.

### BACKGROUND OF THE DISCLOSURE

### Field of the Disclosure

The present disclosure relates to a display control apparatus, a control method, and a storage medium.

### Description of the Related Art

In a case where a size of a display unit mounted on a display control apparatus is small, information displayable on the display unit is limited. For this reason, a user consults a manual in a paper or electronic medium to cope with an unclear point. Some display control apparatuses are provided with a key (two-dimensional code key) for displaying a predetermined code (two-dimensional code), such as a QR code®. The display control apparatus receives operation on the two-dimensional code key from the user, and displays the two-dimensional code that is able to display a manual when read by a terminal apparatus, on the display unit. More specifically, in response to the terminal apparatus including a reading device, such as a camera, reading the two-dimensional code displayed on the display unit of the display control apparatus, a manual corresponding to a uniform resource locator (URL) included in the two-dimensional code is provided to the user.

Japanese Patent Application Laid-Open No. 2024-009943 discusses a technique of switching, in a case where operation on the two-dimensional code key is received from the user, whether to display the two-dimensional code, based on a lighting-on state of the two-dimensional code key.

Japanese Patent Application Laid-Open No. 2024-009943 also discusses a technique of shifting from a screen displaying the two-dimensional code to a screen before the two-dimensional code is displayed, in a case where operation on a hardware key group is received while the two-dimensional code key is displayed. However, depending on the key, even in a case where the key is operated while the two-dimensional code is displayed, execution of processing (hereinafter, normal processing) that is performed in a case where the key is operated while the two-dimensional code is not displayed is demanded in some cases.

### SUMMARY OF THE DISCLOSURE

The present disclosure is directed to a technique of improving user operability of an image processing apparatus.

According to an aspect of the present disclosure, a display control apparatus including an operation unit for receiving operation from a user, and a display unit, the display control apparatus includes a display control unit configured to display a predetermined code on the display unit, and a control unit configured to perform first processing in a case where the predetermined code is not displayed on the display unit and a key with a first attribute included in the operation unit is operated, and to perform second processing in a case where the predetermined code is not displayed on the display unit and a key with a second attribute included in the operation unit is operated, wherein, in a case where the predetermined code is displayed on the display unit, and the key with the first attribute is operated, the control unit performs the first processing, and in a case where the predetermined code is displayed on the display unit, and the key with the second attribute is operated, the control unit performs processing for hiding the predetermined code without performing the second processing.

Further features of the present disclosure will become apparent from the following description of exemplary embodiments with reference to the attached drawings.

### BRIEF DESCRIPTION OF THE DRAWINGS

FIG. 1 is a diagram illustrating a configuration of a system and a schematic appearance configuration of the system.

FIG. 2 is a diagram illustrating an appearance configuration of an operation panel.

FIG. 3 is a block diagram illustrating a schematic functional configuration of an image processing apparatus.

FIG. 4 is a flowchart illustrating two-dimensional code key light-emission control and two-dimensional code display control.

FIG. 5 is a diagram illustrating an operation panel on which the two-dimensional code key is on.

FIG. 6 is a diagram illustrating the operation panel on which a two-dimensional code is displayed.

FIG. 7 is a diagram illustrating the operation panel on which a two-dimensional code key guide is displayed.

FIG. 8 is a flowchart illustrating control of a key while the two-dimensional code is displayed.

FIG. 9 is a table illustrating grouping of keys.

FIG. 10 is a diagram illustrating the operation panel illustrated in FIG. 2, including a sheet size selection key.

### DESCRIPTION OF THE EMBODIMENTS

The present disclosure will be described in detail with reference to the drawings. It should be noted that the following exemplary embodiments are not intended to limit the present disclosure as defined by the claims, and not all combinations of features described in the exemplary embodiments are necessarily essential to the solutions provided by the present disclosure. In the accompanying drawings, the same or similar components are denoted by the same reference numerals, and the redundant descriptions are omitted.

### Appearance Configuration of Display System

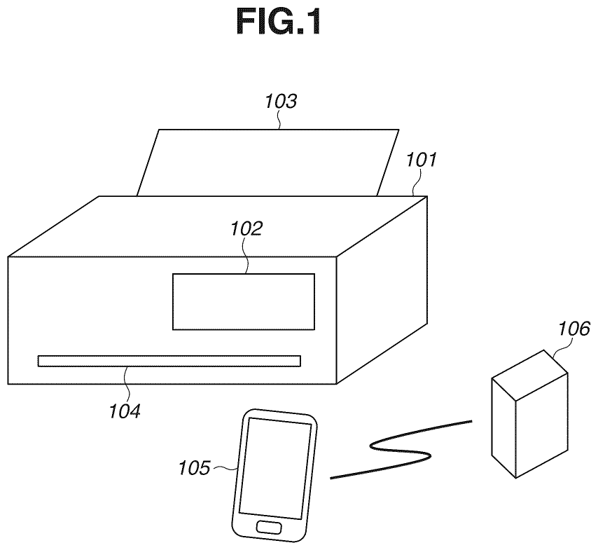

A first exemplary embodiment is described. As illustrated in FIG. 1, a display system mainly includes an image processing apparatus 101 as a display control apparatus, a mobile terminal 105 as a terminal apparatus, and a server apparatus (computer) 106 as an information processing apparatus managing manual information. In the present exemplary embodiment, the image processing apparatus 101 is described as a single function printer (SFP) that is a printing apparatus as an example. A printing medium set in a sheet feeding unit 103 is conveyed one by one to a printing unit, printing processing is performed on the printing medium to record information on the printing medium by using a recording agent, and the resultant printing medium is then discharged from a sheet discharge tray 104.

In the above-described manner, the image processing apparatus 101 generates a printed product in which the printing processing has been performed on the printing medium. An operation panel (operation unit) 102 at least includes keys, and includes hardware keys (physical keys), and a touch panel including software keys. The hardware keys may be provided as software keys, and the operation panel 102 may be integrated with a display unit as a touch panel. The display unit displays various information about the image processing apparatus 101. A central processing unit (CPU) 301 performs display control for displaying the information about the image processing apparatus 101 on the display unit. The operation panel 102 receives operation performed by a user and is provided in an outer surface (housing) of the image processing apparatus 101.

The printing apparatus indicates an apparatus including a recording apparatus that has a printing function of recording information on a printing medium by using a recording agent. A printing method of the printing apparatus may be an electrophotographic method, an inkjet method, or other methods. In a case of the inkjet method, printing means may be printing means that performs printing using ink supplied from a cartridge. The printing means may be a printing means that performs printing using ink replenished and stored in an ink tank provided in an inkjet recording apparatus in place of replacement of the cartridge storing the ink. Further, for example, the display control apparatus may be an apparatus that further includes a reading apparatus reading an image on a document and functions as a copier, or a multifunctional peripheral (MFP) including the other functions. Further, various apparatuses, such as a personal computer (PC), a smartphone, a digital camera, a facsimile apparatus, a mobile terminal, a laptop PC, a tablet terminal, a personal digital assistant (PDA), a music player, a television, and a smart speaker may be applied as the display control apparatus according to the present exemplary embodiment.

The terminal apparatus may be any of various apparatuses, such as a smartphone, a PC, a tablet terminal, and a digital camera.

In FIG. 1, a two-dimensional code displayed on the image processing apparatus 101 is read by the mobile terminal 105, and the mobile terminal 105 accesses the server apparatus 106, based on the read information. As a result, a predetermined manual page is displayed on a screen of the mobile terminal 105.

A communication method for connection between the apparatuses is, for example, Institute of Electrical and Electronics Engineers (IEEE) 802.11 series communication standard (Wi-Fi), or Bluetooth® (Bluetooth® Classic, Bluetooth® Low Energy (Bluetooth® LE), etc.). In the display system according to the present exemplary embodiment, direct connection may be performed between the apparatuses, or communication between the apparatuses may be performed by Internet communication through a wireless LAN router. Each of the apparatuses may perform communication using mobile communication (3G, 4G, or 5G).

### (Operation Panel)

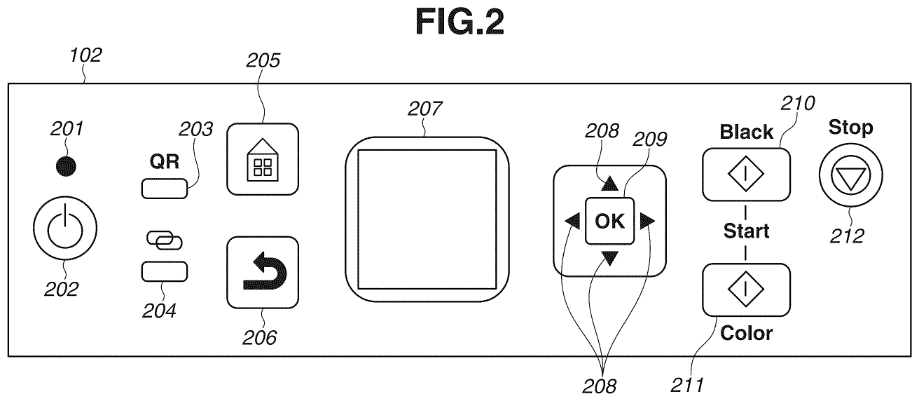

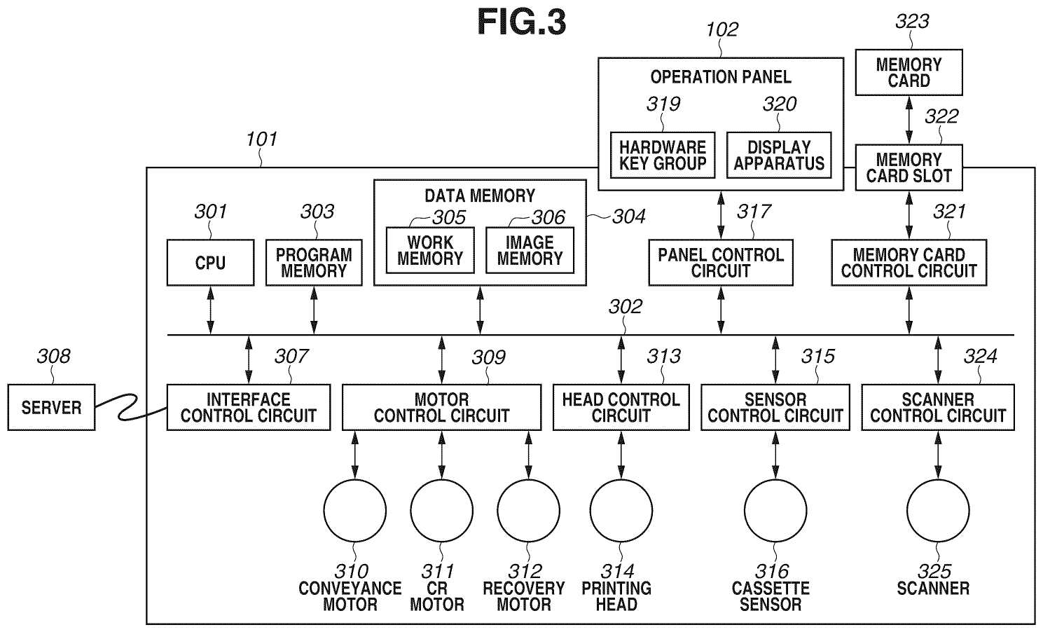

FIG. 2 is a diagram illustrating appearance of the operation panel 102. As illustrated in FIG. 2, the operation panel 102 includes a light-emitting diode (LED) 201, a power key 202, a two-dimensional code key 203, a wireless connection key 204, a home key 205, a back key 206, a liquid crystal display (LCD) 207, direction keys 208, an OK key 209, a monochrome start key 210, a color start key 211, and a stop key 212. The LCD 207 and the LED 201 are included in a display apparatus 320 (see FIG. 3) described below. The LED 201 is, for example, a light emission unit that is lit in a case where the image processing apparatus 101 is in an on state. The power key 202, the two-dimensional code key 203, the wireless connection key 204, the home key 205, the back key 206, the direction keys 208, the OK key 209, the monochrome start key 210, the color start key 211, and the stop key 212 are included in a hardware key group 319 (see FIG. 3) described below. The monochrome start key 210 is a key to execute predetermined processing, such as a copy function in monochrome (with black and white ink), when the monochrome start key 210 is pressed to perform the above-described normal processing (first processing and second processing). The color start key 211 is a key to execute the predetermined processing, such as the copy function in color (with black, white, and color ink), when the color start key 211 is pressed to perform the normal processing. The stop key 212 is a key for termination of the predetermined processing that is currently performed by the image processing apparatus 101 as normal processing. The LCD 207 is, for example, a liquid crystal display. The power key 202 is a key to execute power-off (software-off) processing of the image processing apparatus 101 as normal processing. The home key 205 is a hardware key to execute home screen shifting processing as normal processing, and the back key 206 is a hardware key to execute history screen shifting processing, as normal processing. The direction keys 208 are hardware keys to execute cursor movement processing and scroll processing as normal processing, and the OK key 209 is a hardware key to execute selection finalization processing as normal processing. The two-dimensional code key 203 is a part in which a hardware key and an LED are integrated, and a hardware key itself is lit or off. A light emission mode of the two-dimensional code key 203 is not limited to lighting, and may be blinking or flickering. Light emission control of the two-dimensional code key 203 is performed by the CPU 301 described below. The two-dimensional code key 203 is a hardware key to execute generation of a two-dimensional code. When the two-dimensional code key 203 is pressed, and generation of a two-dimensional code is instructed, a two-dimensional code is generated based on contents displayed on the LCD 207. The LED of the two-dimensional code key 203 indicates an enabled state or a disabled state of the two-dimensional code key. In a case where the two-dimensional code key 203 is enabled, the two-dimensional code key 203 is lit, whereas in a case where the two-dimensional code key 203 is disabled, the two-dimensional code key 203 is off.

The case where the two-dimensional code key is enabled indicates a state where a manual link corresponding to the displayed screen (manual page corresponding to the displayed screen) has been set. The case where the two-dimensional code key is disabled indicates a state where a manual link corresponding to the displayed screen has not been set. The manual link is able to be set for each screen that is displayed on the LCD 207. In a case where the two-dimensional code key 203 is pressed while the two-dimensional code key 203 is lit (two-dimensional code key 203 is enabled), and generation of a two-dimensional code key is instructed, a two-dimensional code is generated based on contents displayed on the LCD 207 and is displayed on the LCD 207.

### Functional Configuration of Image Processing Apparatus

FIG. 3 is a block diagram illustrating a configuration of a control system of the image processing apparatus 101. The CPU 301 in a form of a microprocessor operates based on contents in a program memory 303 in a form of a read only memory (ROM) and a data memory 304 in a form of a random access memory (RAM) connected via an internal bus 302. The data memory 304 is used as a work memory 305 that is used by the CPU 301 in execution of control programs, as an image memory 306 storing image data formed on a recording sheet, and the like. The CPU 301 controls an interface control circuit 307, receives job data to be printed from a server 308 connected to a network via an external interface, and notifies the server 308 of a status of the image processing apparatus 101. The CPU 301 controls various kinds of motors that drive mechanisms of the image processing apparatus 101 via a motor control circuit 309. A conveyance motor 310 drives a sheet feeding roller, a conveyance roller, and a sheet discharge roller, and conveys the recording sheet from the sheet feeding unit 103 to the sheet discharge tray 104. A carriage motor 311 (CR motor in drawing) causes a carriage to reciprocate. A recovery motor 312 drives a head recovery mechanism, and controls the mechanism in synchronization with driving of the carriage to perform recovery operation which is to keep a printing head 314 in an appropriate state.

The CPU 301 controls the printing head 314 via a head control circuit 313. The CPU 301 controls the printing head 314 in synchronization with reciprocating operation of the carriage to form an image on the recording sheet. A cassette sensor 316 for the sheet feeding unit 103 includes a photo-interrupter and a mechanical switch. The cassette sensor 316 detects that the user has set a sheet in the sheet feeding unit 103 of the image processing apparatus 101 or the user has removed a sheet from the sheet feeding unit 103, and the CPU 301 acquires the detection via a sensor control circuit 315. The CPU 301 controls the operation panel 102 disposed in the outer surface of the image processing apparatus 101 via a panel control circuit 317. The CPU 301 displays desired information on the display apparatus 320 disposed in the operation panel 102, and monitors operation performed by the user on the hardware key group 319 on the operation panel 102. The CPU 301 controls a scanner 325 (not illustrated in FIG. 1) via a scanner control circuit 324, and reads an image of a document placed on a document table of the scanner 325. The CPU 301 reads and writes, via a memory card control circuit 321, various kinds of files in a memory card 323 mounted on a memory card slot 322 provided in the outer surface of the image processing apparatus 101. An image read by the scanner 325 is stored in the image memory 306 of the data memory 304, and then, the image may be transmitted to the server 308 or stored as an image file in the memory card 323. The image read by the scanner 325 is directly printed by controlling a printing mechanism, which is also usable as a copy function.

### Operation of Image Processing Apparatus

Although the image processing apparatus 101 performs processing corresponding to various kinds of functions, two-dimensional code display control processing will be mainly described.

### Two-Dimensional Code Display Control Processing

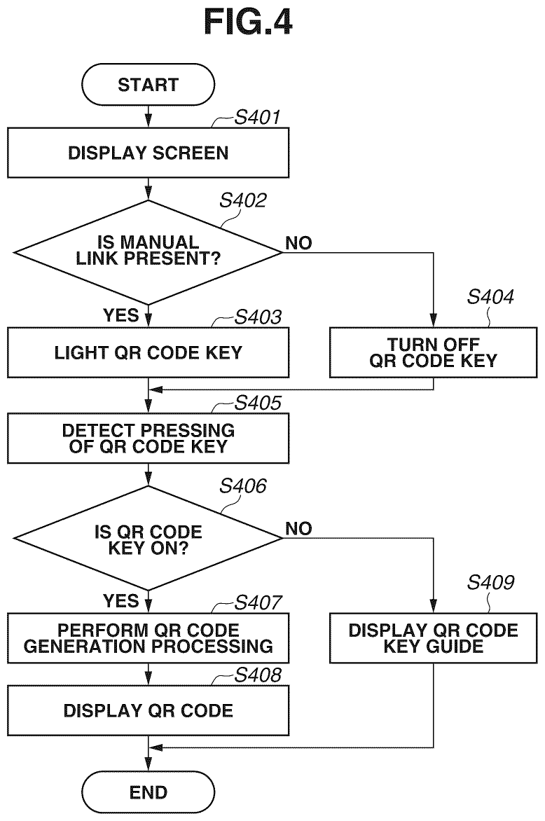

FIG. 4 is a flowchart illustrating the two-dimensional code display control

processing. The processing in the flowchart is started in response to shifting to a predetermined screen.

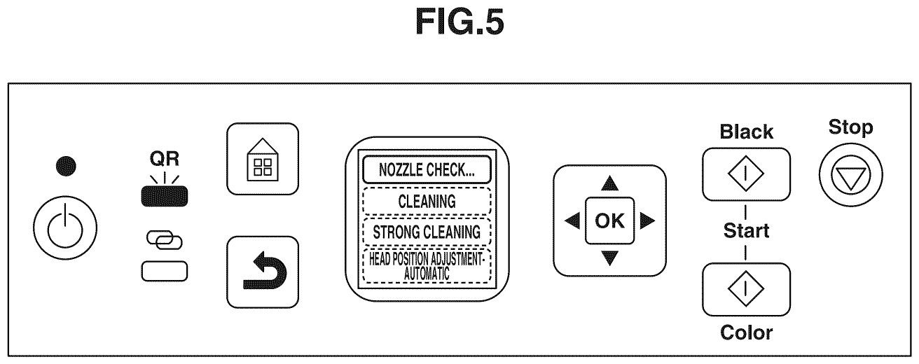

In step S401, the CPU 301 displays a screen corresponding to user operation, on the LCD 207. In step S402, the CPU 301 determines whether a manual link corresponding to the displayed screen is present. In a case where the CPU 301 determines that the manual link is present (YES in step S402), the processing proceeds to step S403. In a case where the CPU 301 determines that no manual link is present (NO in step S402), the processing proceeds to step S404. In step S403, the CPU 301 lights the two-dimensional code key 203 (changes two-dimensional code key from lighting-off state to lighting-on state, or maintains lighting-on state in case where two-dimensional code key 203 has been on in previous screen). In step S404, the CPU 301 turns off the two-dimensional code key 203 (changes two-dimensional code key 203 from lighting-on state to lighting-off state, or maintains lighting-off state in case where two-dimensional code key 203 has been off in previous screen). FIG. 5 illustrates an example of the operation panel 102 on which the two-dimensional code key 203 is lit.

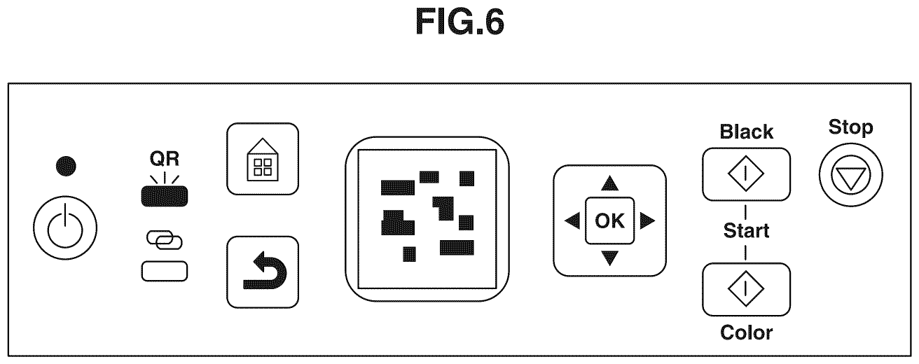

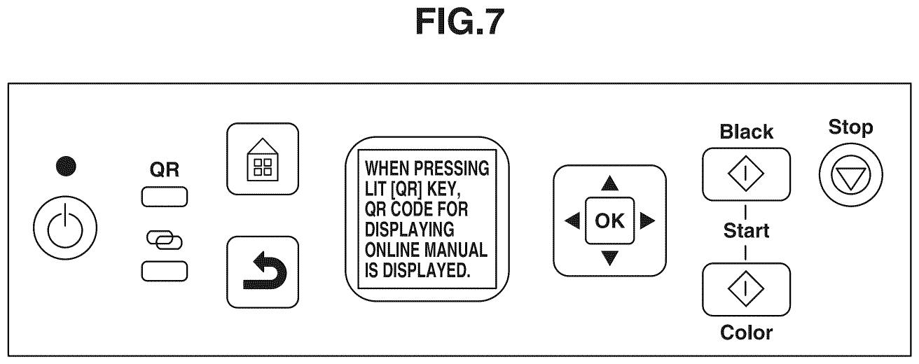

In step S405, the CPU 301 detects pressing of the two-dimensional code key 203 (user operation performed on two-dimensional code key 203). In step S406, the CPU 301 determines whether the two-dimensional code key 203 is on. In a case where the CPU 301 determines that the two-dimensional code key 203 is on (YES in step S406), the processing proceeds to step S407. In a case where the CPU 301 determines that the two-dimensional code key 203 is not on (NO in step S406), the processing proceeds to step S409. In step S407, the CPU 301 performs two-dimensional code generation processing. In step S408, the CPU 301 performs two-dimensional code display control processing (FIG. 6). In step S409, the CPU 301 performs two-dimensional code key guide display control processing (FIG. 7). In other words, the CPU 301 performs one of the two-dimensional code display control processing in step S408 and the two-dimensional code key guide display control processing in step S409. The processing in the flowchart of FIG. 4 then ends.

FIG. 5 illustrates the example of the operation panel 102 on which the two-dimensional code key 203 is on. Since the manual link corresponding to the screen displayed on the LCD 207 is present, the two-dimensional code key 203 is on.

FIG. 6 illustrates an example of the operation panel 102 on which a two-dimensional code is displayed on the LCD 207, and the two-dimensional code is displayed on the LCD 207. For example, in a case where the two-dimensional code key 203 is operated in the state illustrated in FIG. 5, the two-dimensional code is displayed on the entire screen of the LCD 207 as illustrated in FIG. 6.

FIG. 7 illustrates an example of the operation panel 102 on which the two-dimensional code key guide is displayed, and the two-dimensional code key guide is displayed on the LCD 207. As the two-dimensional code key guide, for example, explanation (character information) that, when the two-dimensional code key 203 being on is pressed, a two-dimensional code for displaying a manual is displayed, is displayed. In a case where pressing of the two-dimensional code key 203 is detected while the two-dimensional code key 203 is off, information indicating absence of an available two-dimensional code may be displayed on the LCD 207.

### Hardware Key Control While Two-Dimensional Code is Displayed

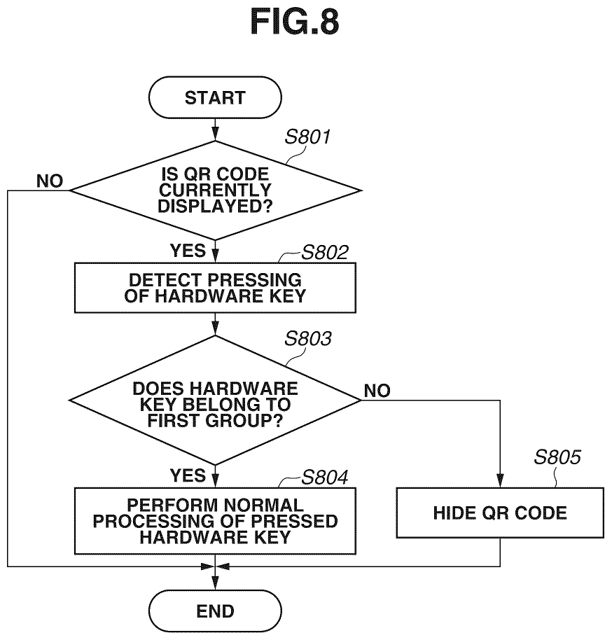

FIG. 8 is a flowchart illustrating hardware key control while the two-dimensional code is displayed. Processing in the flowchart is started based on shifting to a predetermined screen.

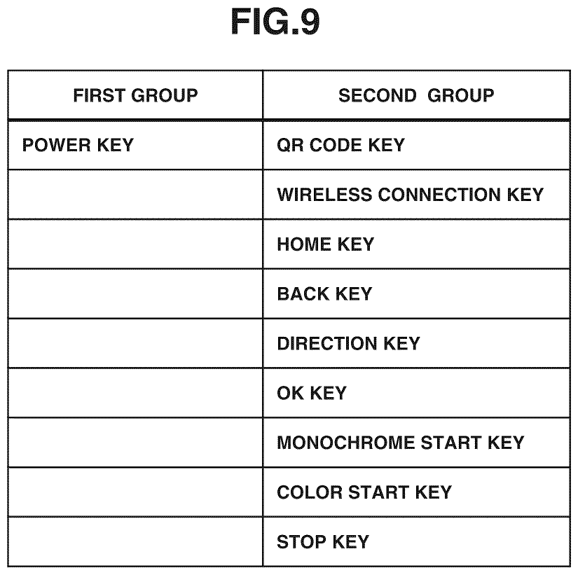

In step S801, the CPU 301 determines whether the two-dimensional code is currently displayed on the LCD 207. In a case where the CPU 301 determines that the two-dimensional code is currently displayed (YES in step S801), the processing proceeds to step S802. In a case where the CPU 301 determines that the two-dimensional code is not currently displayed (NO in step S801), the processing in the flowchart ends. In step S802, the CPU 301 detects pressing of a hardware key. More specifically, the CPU 301 receives operation performed on the hardware key group 319 illustrated in FIG. 3 described above. In step S803, the CPU 301 determines whether the pressed hardware key belongs to a first group. In a case where the CPU 301 determines that the pressed hardware key belongs to the first group (is key with first attribute) (YES in step S803), the processing proceeds to step S804. In a case where the CPU 301 determines that the pressed hardware key does not belong to the first group (is key with second attribute) (NO in step S803), the processing proceeds to step S805. In the present exemplary embodiment, as described below with reference to FIG. 9, the power key 202 belongs to the first group, and the other hardware keys belong to a second group. In step S804, the CPU 301 performs normal processing of the pressed hardware key. For example, in a case where the power key 202 is pressed in a state where the image processing apparatus 101 is started, software-off processing of the image processing apparatus 101 is performed. In step S805, the CPU 301 hides the two-dimensional code displayed on the LCD 207 and performs processing for shifting the screen to a previous screen before the two-dimensional code is displayed. For example, in a case where the two-dimensional code key 203 is pressed while a maintenance menu screen is displayed, the CPU 301 displays the two-dimensional code. Further, in a case where the hardware key other than the power key 202 is pressed, the CPU 301 hides the two-dimensional code and displays the maintenance menu screen. In other words, in a case where the hardware key not belonging to the first group is pressed while the two-dimensional code is displayed, the CPU 301 performs processing for hiding the two-dimensional code displayed on the LCD 207 without performing normal processing of the pressed hardware key not belonging to the first group. It has been described that, in step S805, the CPU 301 hides the two-dimensional code displayed on the LCD 207 and performs the processing for shifting the screen to the previous screen before the two-dimensional code is displayed. However, at least in step S805, the CPU 301 may hide the two-dimensional code displayed on the LCD 207 and may not perform the processing for shifting the screen to the previous screen. In this case, for example, a screen different from the previous screen may be displayed on the LCD 207.

The determination whether each hardware key belongs to the first group is performed based on a previously determined table illustrated in FIG. 9, for example. In the example illustrated in FIG. 9, a hardware key belonging to the first group is the power key, and keys belonging to the second group are hardware keys other than the power key. However, the grouping is not limited thereto, and a hardware key other than the power key may belong to the first group, or one or a plurality of hardware keys other than the power key may belong to the first group. The groups of the hardware keys may not be managed by the table as illustrated in FIG. 9. A table may be determined for each screen corresponding to the two-dimensional code, and a table to be referred may be changed for each displayed screen. In other words, by providing tables different in hardware keys included in the first group and associating the tables with respective screens, the hardware keys set to execute the normal processing and the hardware keys set to execute the two-dimensional code hiding processing is changeable in accordance with the screen.

In the example illustrated in FIG. 9, when the power key is pressed by the user while the two-dimensional code is displayed, the software-off processing of the image processing apparatus 101 is performed, whereas when the hardware key other than the power key is pressed by the user while the two-dimensional code is displayed, the processing for hiding the two-dimensional code is performed. In other words, the processing for shifting the screen to the previous screen before the two-dimensional code is displayed is performed. More specifically, for example, even in a case where the two-dimensional code key is pressed while the maintenance menu screen is displayed, the two-dimensional code is displayed, the home key 205 is pressed by the user while the two-dimensional code is displayed, and the two-dimensional code is hidden, the screen is not shifted to the home screen, and the maintenance menu screen that is the previous screen before the two-dimensional code is displayed is displayed.

In the above-described exemplary embodiment, even in a case where a predetermined key is operated while the two-dimensional code is displayed on the display unit, when the predetermined key is a key in which execution of the corresponding normal processing is required, the corresponding normal processing is performed. This improves usability of the user who demands execution of the normal processing corresponding to the predetermined key. The user can hide the two-dimensional code without shifting the screen to the home screen by pressing the home key while the two-dimensional code is displayed on the display unit. In other words, this configuration reduces confusion of user operation for hiding the two-dimensional code. Further, the user can hide the two-dimensional code by pressing a key that is not a hardware key, the corresponding normal processing of which is the processing for shifting the screen, such as a color start key and a stop key. Therefore, the two-dimensional code is more easily hidden, which improves operability of the user.

In the above-described exemplary embodiment, the normal processing of each hardware key and the two-dimensional code hiding processing are changed based on whether the pressed hardware key belongs to the first group. Alternatively, the normal processing of each hardware key and the two-dimensional code hiding processing may be switched based on a pressing time performed on the hardware key that is pressed while the two-dimensional code is displayed. For example, in a case where an operation time performed on a first hardware key is shorter than a predetermined threshold, the first hardware key is determined to belong to the first group, whereas in a case where the operation time performed on the first hardware key is longer than the predetermined threshold, the first hardware key is determined to belong to the second group. Alternatively, in the case where the operation time performed on the first hardware key is longer than the predetermined threshold, the first hardware key may be determined to belong to the first group, whereas in the case where the operation time performed on the first hardware key is shorter than the predetermined threshold, the first hardware key may be determined to belong to the second group. The user may set a hardware key belonging to the first group (or hardware key belonging to second group) by selecting a hardware key on a predetermined setting screen in the image processing apparatus 101. This enables the user to customize the hardware key set to execute the normal processing and the hardware key set to execute the two-dimensional code hiding processing in the case where each hardware key is pressed while the two-dimensional code is displayed. This improves usability.

In the above-described exemplary embodiment, the image processing apparatus 101 may include a sound processing unit, and in a case where the hardware key pressed while the two-dimensional code is displayed is a hardware key set to execute the normal processing, the sound processing unit may output sound different from key-touch sound in a case where the two-dimensional code hiding processing is performed. Alternatively, in a case where the hardware key pressed while the two-dimensional code is displayed is a hardware key set to execute the two-dimensional code hiding processing, the sound processing unit may output sound different from key-touch sound in a case where the normal processing is performed. In other words, the sound in the case where the normal processing is performed and the sound in the case where the two-dimensional code hiding processing is performed may be made different from each other such that execution of the normal processing and execution of the two-dimensional code hiding processing are distinguishable from each other while the two-dimensional code is displayed on the display unit.

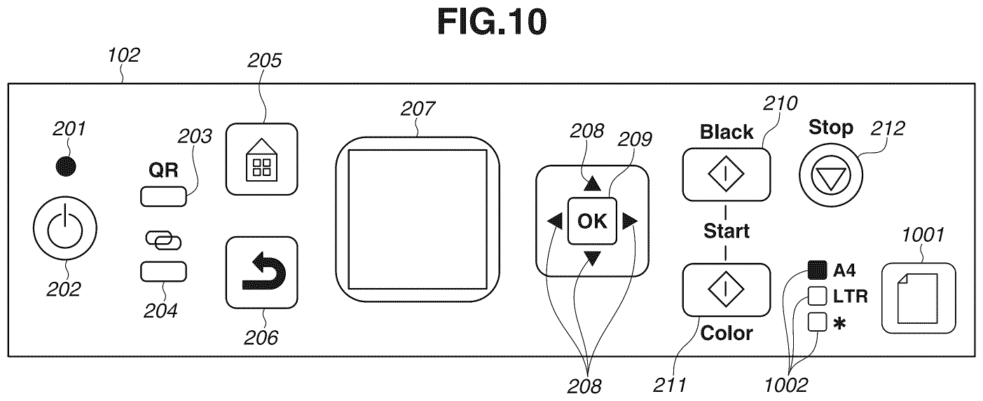

A second exemplary embodiment is described. FIG. 10 is a diagram illustrating a configuration in which a sheet size selection key 1001 is included in the operation panel 102 illustrated in FIG. 2. In a case where the sheet size selection (setting) key 1001 is pressed by the user, the CPU 301 turns on any of LEDs 1002 indicating a sheet size. In place of lighting-on, light emission control of blinking, flickering, and the like may be performed. Specifically, in the case where the sheet size selection key 1001 is pressed, the CPU 301 turns on any of the LEDs 1002, and in a case where the sheet size selection key 1001 is pressed again, the CPU 301 turns on one of the LEDs 1002 different from the LED 1002 currently lit. In other words, the CPU 301 turns on the LEDs 1002 indicating the respective sheet sizes in a predetermined order in response to pressing of the sheet size selection key 1001, and receives setting/change of a setting value of the sheet size to be used in the predetermined processing. As described above, the processing for setting/changing the setting value of the sheet size is normal processing corresponding to operation performed on the sheet size selection key 1001. In the present exemplary embodiment, the sheet size selection key 1001 is included in the first group according to the first exemplary embodiment. In other words, in a case where the sheet size selection key 1001 is operated while the two-dimensional code is displayed, the CPU 301 performs the normal processing of the sheet size selection key 1001. In other words, the CPU 301 performs the processing for setting/changing the set value of the sheet size. As a result, the user can change the sheet size setting by pressing the sheet size selection key 1001 while the two-dimensional code is displayed. In the case where the sheet size selection key 1001 is operated while the two-dimensional code is displayed, the CPU 301 performs the normal processing of the sheet size selection key 1001 while the two-dimensional code is still displayed.

In the above-described exemplary embodiments, while the two-dimensional code is described as an example of the code, the code is not limited to the two-dimensional code, and may be a two-dimensional barcode, a three-dimensional code, the other code, or information in another form as long as the information includes the manual link.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like. While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-087665, filed May 30, 2024, which is hereby incorporated by reference herein in its entirety.

What is claimed is:

1. A display control apparatus including an operation unit for receiving operation from a user, and a display unit, the display control apparatus comprising:
a display control unit configured to display a predetermined code on the display unit; and
a control unit configured to perform first processing in a case where the predetermined code is not displayed on the display unit and a key with a first attribute included in the operation unit is operated, and to perform second processing in a case where the predetermined code is not displayed on the display unit and a key with a second attribute included in the operation unit is operated,
wherein, in a case where the predetermined code is displayed on the display unit, and the key with the first attribute is operated, the control unit performs the first processing, and in a case where the predetermined code is displayed on the display unit, and the key with the second attribute is operated, the control unit performs processing for hiding the predetermined code without performing the second processing.

2. The display control apparatus according to claim 1, wherein, in the case where the predetermined code is displayed on the display unit, and the key with the first attribute is operated, the control unit performs the first processing, and in the case where the predetermined code is displayed on the display unit, and the key with the second attribute is operated, the control unit performs processing for hiding the predetermined code and displaying a previous screen before a screen displaying the predetermined code without performing the second processing.

3. The display control apparatus according to claim 1, wherein the key with the first attribute is a power key to execute software-off processing of the display control apparatus.

4. The display control apparatus according to claim 1, wherein the key with the first attribute is a sheet size selection key to execute processing for selecting a sheet to be used in predetermined processing of the display control apparatus.

5. The display control apparatus according to claim 4, wherein, in the case where the predetermined code is displayed on the display unit, and the key with the first attribute is operated, the control unit performs the first processing without performing the processing for hiding the predetermined code.

6. The display control apparatus according to claim 1, wherein the key with the second attribute is a home key to execute processing for shifting from a predetermined screen displayed on the display unit to a home screen.

7. The display control apparatus according to claim 6, wherein, in a case where the predetermined code is displayed on the display unit, and the home key is operated, the control unit performs the processing for hiding the predetermined code without performing the processing for shifting from the predetermined screen to the home screen.

8. The display control apparatus according to claim 1,
wherein the key with the first attribute and the key with the second attribute are a same predetermined key, and
wherein, in a case where an operation time for the predetermined key is shorter than a predetermined threshold, the predetermined key belongs to the first attribute, and in a case where the operation time for the predetermined key is longer than the predetermined threshold, the predetermined key belongs to the second attribute.

9. The display control apparatus according to claim 1,
wherein the key with the first attribute and the key with the second attribute are a same predetermined key, and
wherein, in a case where an operation time for the predetermined key is longer than a predetermined threshold, the predetermined key belongs to the first attribute, and in a case where the operation time for the predetermined key is shorter than the predetermined threshold, the predetermined key belongs to the second attribute.

10. The display control apparatus according to claim 1, wherein the key with the first attribute and the key with the second attribute are hardware keys included in the operation unit.

11. The display control apparatus according to claim 1, wherein the predetermined code is displayed on an entire screen of the display unit.

12. The display control apparatus according to claim 1, further comprising an output unit configured to output, in a case where the key with the first attribute is operated, sound different from touch sound output in a case where the key with the second attribute is operated.

13. A control method of a display control apparatus including an operation unit for receiving operation from a user, and a display unit, the control method comprising:
displaying a predetermined code on the display unit; and
performing control to perform first processing in a case where the predetermined code is not displayed on the display unit, and a key with a first attribute included in the operation unit is operated, and to perform second processing in a case where the predetermined code is not displayed on the display unit, and a key with a second attribute included in the operation unit is operated,
wherein, in a case where the predetermined code is displayed on the display unit, and the key with the first attribute is operated, the performing control performs the first processing, and in a case where the predetermined code is displayed on the display unit, and the key with the second attribute is operated, the performing control performs processing for hiding the predetermined code without performing the second processing.

14. A non-transitory computer-readable storage medium storing a program that causes a computer of a display control apparatus including an operation unit for receiving operation from a user, and a display unit, to perform a process which comprises:
displaying a predetermined code on the display unit; and
performing control to perform first processing in a case where the predetermined code is not displayed on the display unit, and a key with a first attribute included in the operation unit is operated, and to perform second processing in a case where the predetermined code is not displayed on the display unit, and a key with a second attribute included in the operation unit is operated,
wherein, in a case where the predetermined code is displayed on the display unit, and the key with the first attribute is operated, the performing control performs the first processing, and in a case where the predetermined code is displayed on the display unit, and the key with the second attribute is operated, the performing control performs processing for hiding the predetermined code without performing the second processing.
